(19) United States
(12) Patent Application Publication
(10) Pub. No.: US 2007/0126293 A1
(43) Pub. Date: Jun. 7, 2007

(54) Decorative lighting device

(76) Inventor: Kuang-Chieh Wu, Hsin Chu Hsien (TW)

Correspondence Address: LEONG C LEI, PMB # 1008, 1867 YGNACIO VALLEY ROAD, WALNUT CREEK, CA, 94598, US

(21) Appl. No.: 11/290,546

(22) Filed: Dec. 1, 2005

(51) Int. Cl. H02K 5/24; H02K 7/18

(52) U.S. Cl. 310/73; 310/51; 290/1 R

(57) ABSTRACT

A decorative lighting device includes a casing, a generator assembly including an armature spindle which rotates to induce relative rotation in an electrical winding-magnet system, a counter weight device, and at least one illuminating element. The casing is attachable to a rotary body to be rotated with the rotary body. The casing defines an interior space to receive the generator assembly in such a way that the armature spindle is fixed to and rotates with the casing. The counter weight device is fixed to the generator assembly and is constructed to maintain the gravity center of the generator assembly downward by means of eccentric counterbalancing. The illuminating element is electrically connected to the generator assembly. When the rotary body rotates, a relative rotation is caused between the electrical winding and the magnet of the generator assembly to induce electrical power by electromagnetic induction. The power is then supplied to the illuminating element for emission of light.

### BACKGROUND OF THE INVENTION

(a) Technical Field of the Invention

The present invention generally relates to a decorative lighting device, and in particular to a decorative lighting device that is readily mounted to a rotation axis of a rotary body to make use of the rotation of the rotary body to generate electrical power and powering illuminating elements to emit light.

(b) Description of the Prior Art

Due to the improvement in living standard, and also due to the increase of modern commercial activities, decoration with light is now of great attraction to general consumers. It is thus a great challenge for manufacturers in various fields, including entertainment, exercising, decorative articles, education, and transportation, to develop relative products to suit the need of markets.

Conventional decorative lighting is classified as dynamic type and static type. For the later, to increase the operation period, the lighting device is often powered by electric main by plugging into for example a wall outlet. The former, however, is often powered by internal or built-in power source, such as battery, to allow for portability. Examples include transportation vehicles, exercising devices, helmets.

The conventional designs, although effective in generating lighting for different purposes, can still be further improved to offer better economic and operation benefits. Thus, the present invention is aimed to provide an improvement of lighting devices that is readily fixed to a rotary body to make use of the rotational motion of the rotary body for generation and supply of power to illuminating elements that emits light.

### SUMMARY OF THE INVENTION

The primary purpose of the present invention is to provide a decorative lighting device that can be readily mounted to a rotary body that is driven by motor power, human power, wind power, or hydraulic power to induce rotation for generation of power that drives illuminating elements to emit light thereby achieving advantages in both economic aspect and practical use.

To realize the above object, the present invention provides a decorative lighting device comprising a casing, a generator assembly comprising an armature spindle which rotates to induce relative rotation in an electrical winding-magnet system, a counter weight device, and at least one illuminating element. The casing is attachable to a rotary body to be rotated with the rotary body. The casing defines an interior space to receive the generator assembly in such a way that the armature spindle is fixed to and rotates with the casing. The counter weight device is fixed to the generator assembly and is constructed to maintain the gravity center of the generator assembly downward by means of eccentric counterbalancing. The illuminating element is electrically connected to the generator assembly. When the rotary body rotates, a relative rotation is caused between the electrical winding and the magnet of the generator assembly to induce electrical power by electromagnetic induction. The power is then supplied to the illuminating element for emission of light.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a decorative lighting device constructed in accordance with a first embodiment of the present invention;

FIG. 2 is an assembled view of the decorative lighting device of the first embodiment of the present invention;

FIG. 3 is a front view of the decorative lighting device in accordance with the first embodiment of the present invention;

FIG. 4 is a cross-sectional view of the decorative lighting device in accordance with the first embodiment of the present invention;

FIG. 5 is a perspective view illustrating an application of the decorative lighting device of the first embodiment of the present invention;

FIG. 6 is a perspective view illustrating another application of the decorative lighting device of the first embodiment of the present invention;

FIG. 7 is a side elevated view, partly sectioned, illustrating an application of a decorative lighting device constructed in accordance with a second embodiment of the present invention;

FIG. 8 is a side elevated view, partly sectioned, illustrating another application of the decorative lighting device of the second embodiment of the present invention; and

FIG. 9 is a cross-sectional view, illustrating an application of a decorative lighting device constructed in accordance with a third embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

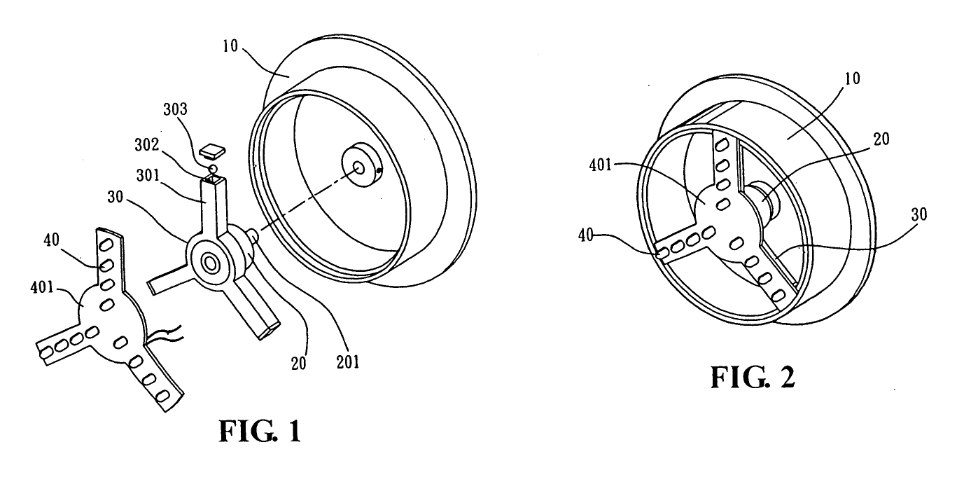

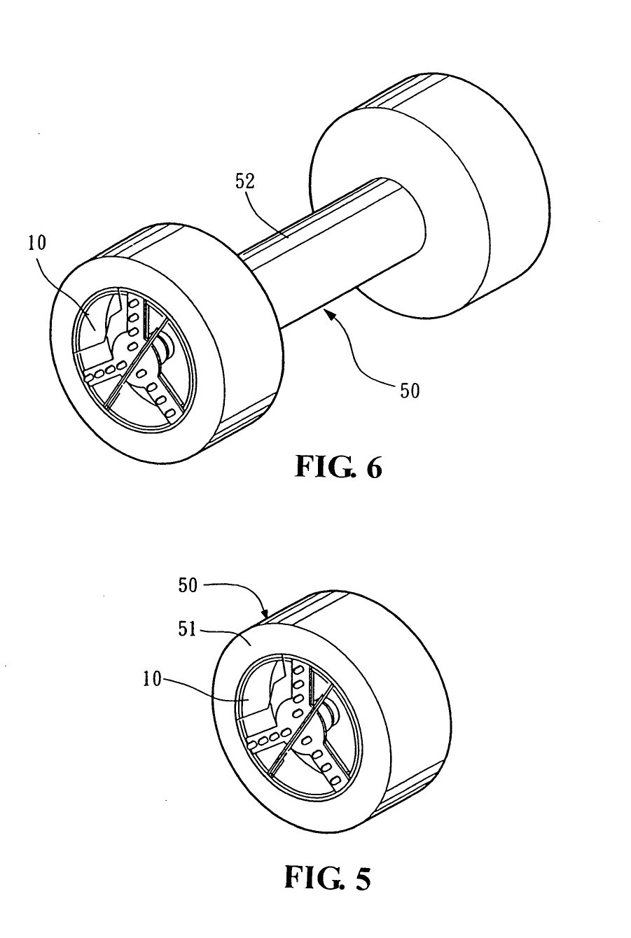

With reference to the drawings and in particular to FIGS. 1-4, a decorative lighting device constructed in accordance with a first embodiment of the present invention comprises a casing (10), a generator assembly (20), a counter weight device (30), and a plurality of illuminating elements (40). The casing (10) defines an interior space for receiving and retaining parts of the decorative lighting device of the present invention therein and is adapted to coaxially attach to a rotational axis of a rotary body 50 (see FIG. 5) that is external to the decorative lighting device of the present invention. The casing 10 has a back wall forming, at a center thereof, a receiving bore (not labeled) to receive and retain an end of an armature spindle (201) of the generator assembly (20).

The generator assembly (20) generates electricity by relative motion induced between electrical windings and magnets, which are arranged inside the generator assembly (20) to form an electromagnetic inductive power generation device, by the rotation of the armature spindle (201) with respect to the generator assembly (20). The electromagnetic inductive power generation is well known and similar to that employed in a bicycle dynamo and thus no further detail is needed herein.

The counter weight device (30) comprises a hub (not labeled) fit over and fixed to the generator assembly (20) and a plurality of radially extending arms (301). Each arm (301) defines a linearly extending channel (302) movably receiving at least one steel ball (303) to induce eccentric counterbalancing that allows the generator assembly (20) to be supported on the armature spindle (201) in a condition that constantly keeps the gravity center of the generator assembly (20) downward. Thus, relative rotation between the armature spindle (201) and the generator assembly (20) is realized.

The illuminating elements (40) are preferably low power consumption lighting devices, such as light-emitting diodes, but not limited thereto. The decorative lighting device of the present invention comprises at least one illuminating element (40) mounted on a circuit board (401) and in electrical connection with the generator assembly (20) to be powered thereby.

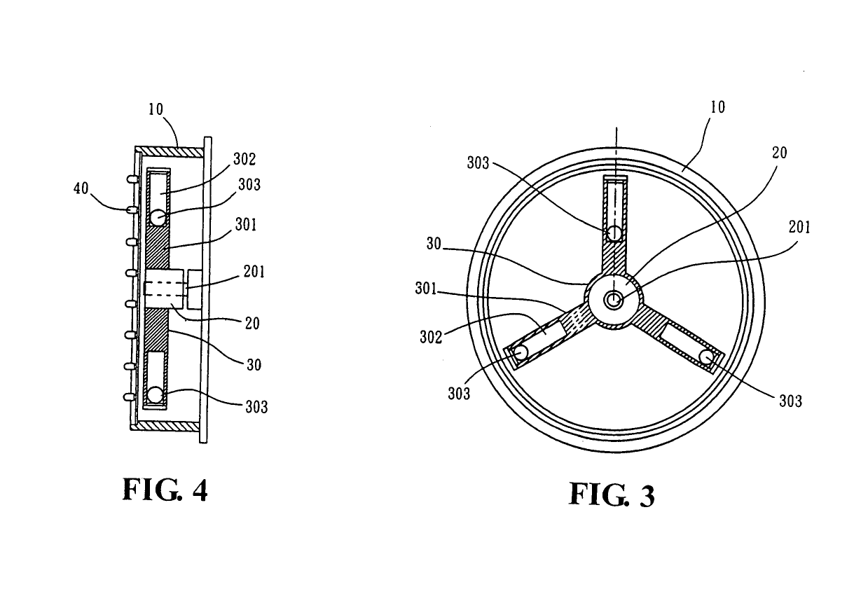

Also referring to FIG. 5, the rotary body (50) to which the decorative lighting device of the present invention is coupled, includes a roller or wheel of a wheel- or roller-based power-driven or manually-driven moving device, such as a wheel (51) of a power vehicle or human power vehicle. Alternatively, and as shown in FIG. 6, the rotary body (50) is a rotary toy, such as a diabolo (52), or a yo-yo. To operate, the casing (10) is attached to the rim of the wheel (51) or an end face of a rotary axle of the diabolo (52). When the wheel (51) or the diabolo (52) is rotated, as illustrated in FIGS. 3 and 4, the eccentric counterbalancing of the counter weight device (30) causes rotation of the generator assembly (20) with respect to the armature spindle (201) to induce relative rotary motion between the windings and the magnets inside the generator assembly (20) thereby inductively generating electrical power, which is supplied to the illuminating elements (40) to cause emission of light. Thus, the present invention provides easy coupling of the lighting device to various types of rotary body to effect self-powering for lighting decoration.

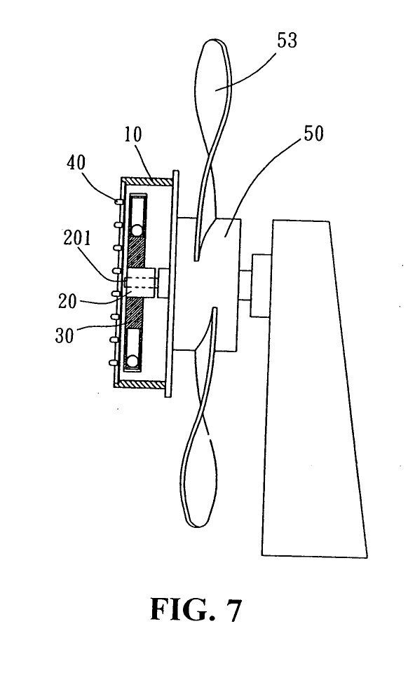

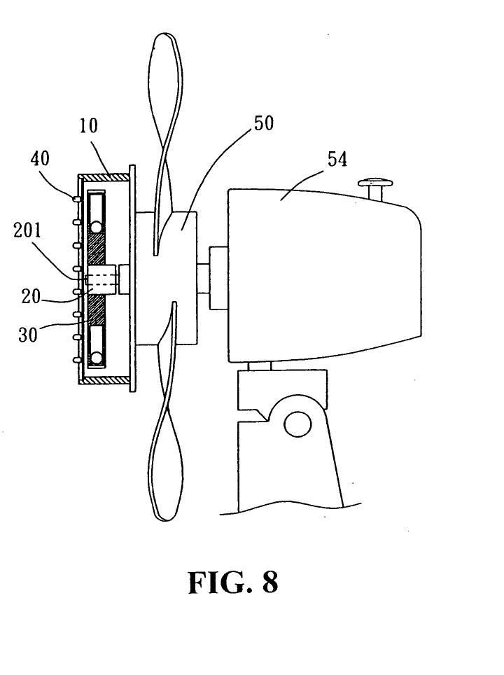

It is noted that the rotary body (50) to which the decorative lighting device of the present invention can be coupled, may also include a windmill-like blade assembly (53), as shown in a second embodiment of the present invention illustrated in FIG. 7, which is rotated by for example an air flow or winds. Alternatively, and as shown in FIG. 8, which illustrates a different application of the present invention, the rotary body (50) can be driven by for example an electric motor (54), such as the motor of an electrical fan wherein the rotary body is the blade hub of the electric fan.

Besides serving as decorative lighting, the lighting device of the present invention can also be used as a night lamp.

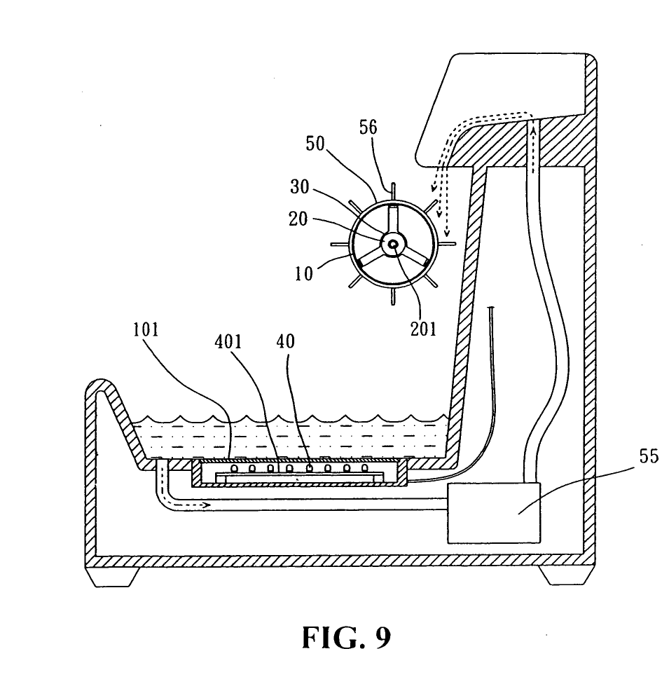

As a further variation of the lighting device of the present invention, the rotary body (50) to which the lighting device of the present invention is coupled, may comprise a hydraulics-based system, as shown in the third embodiment of the present invention illustrated in FIG. 9, wherein a pump (55) is employed to drive liquid, such as water, through piping from a liquid container located at a low level to a high level from which the liquid is allowed to free fall into the liquid container thereby completing circulation of the liquid. The liquid falling from the high level impinges a watermill (56) to which the casing (10) of the decorative lighting device of the present invention is coaxially mounted. The watermill (56), being driven by the falling liquid, drives the rotation of the armature spindle (201) of the generator assembly (20).

Further, besides the arrangement of the illuminating elements (40) soldered to the circuit board (401) that is fixed in the casing (10) as illustrated in previous embodiments, the illuminating elements (40) can be arranged outside the casing (10), as shown in FIG. 9, and if desired, an additional light-transmitting cover (101) can be employed to shield and protect the illuminating elements (40), as well as the circuit board (401). This provides flexibility in practicing the present invention.

Although the present invention has been described with reference to the preferred embodiments thereof, it is apparent to those skilled in the art that a variety of modifications and changes may be made without departing from the scope of the present invention which is intended to be defined by the appended claims. For example, the counter weight device, which as shown previously has three radially extending arms, can be shaped differently provided the eccentric counterbalancing is realized.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A decorative lighting device, comprising a casing, a generator assembly comprising an armature spindle and electrical winding-magnet system, a counter weight device, and at least one illuminating element, wherein the casing is adapted to attach to a rotary body to be rotated with the rotary body, the casing defining an interior space that receives the generator assembly in such a way that the armature spindle is fixed to and rotates with the casing, the counter weight device being fixed to the generator assembly and constructed to maintain the gravity center of the generator assembly downward by means of eccentric counterbalancing, the illuminating element being electrically connected to the generator assembly, whereby when the rotary body rotates, a relative rotation is caused between the electrical winding and the magnet of the generator assembly to induce electrical power by electromagnetic induction, which power is supplied to the illuminating element for emission of light.

2. The decorative lighting device as claimed in claim 1, wherein the rotary body is driven by an external power selected from a group consisting of motor power, wind power, human power and hydraulic power.

3. The decorative lighting device as claimed in claim 1, wherein the counter weight device comprises a hub fit over and fixed to the generator assembly and a plurality arms radially extending from the hub, each arm forming a linear channel movably receiving at least one steel ball.

4. The decorative lighting device as claimed in claim 1, wherein the illuminating element comprises a light-emitting diode.

5. The decorative lighting device as claimed in claim 1, wherein the illuminating element is mounted to the casing or arranged outside the casing.
